(19) United States
(12) Patent Application Publication
(10) Pub. No.: US 2021/0187887 A1
(43) Pub. Date: Jun. 24, 2021

(54) TIRE BUILDING DRUM AND METHOD OF BUILDING A TIRE

(71) Applicant: The Goodyear Tire & Rubber Company, Akron, OH (US)

(72) Inventors: George Michael Stoila, Tallmadge, OH (US); Michael James Hogan, Tallmadge, OH (US); Joshua David Phillips, Uniontown, OH (US)

(21) Appl. No.: 16/950,991

(22) Filed: Nov. 18, 2020

Related U.S. Application Data
(60) Provisional application No. 62/951,553, filed on Dec. 20, 2019.
(60) Provisional application No. 62/951,635, filed on Dec. 20, 2019.

(51) Int. Cl. B29D 30/24; B29D 30/26

(52) U.S. Cl. CPC B29D 30/247; B29D 2030/265; B29D 30/26

(57) ABSTRACT

The tire building drum includes a rotatable drum having a center section and a first and second shoulder section. The center section is radially expandable, and the center section has a first and second shoulder, wherein the first and second shoulders are sloped. The method of building a tire includes the steps of applying an inner liner and a layer of ply to the drum and then a bead, locking the bead into position, applying an apex to each of the sloped shoulders, turning up the ply over the bead and the apex, and then applying a down ply over the ply ending.

### FIELD OF THE INVENTION

The invention relates to a tire drum, and a method of building a tire.

### BACKGROUND OF THE INVENTION

Current tire building drums typically are cylindrical surfaces useful for the application of various tire components such as plies. FIG. 8 illustrates the conventional tire building process, wherein a tire building drum capable of crowning is used. As shown FIG. 8b, the beads are locked, the drum is expanded radially outward, and the apex is applied so that the tip is located radially outward of the bead. As shown in FIG. 8c, the ply is then turned up around the bead and apex, and then additional components such as a down ply, a second apex and/or chafer is then applied (FIG. 8d). As shown in FIG. 8e, the entire assembly is then turned down (rotated clockwise) on a different station. After application of several tire components of varying thicknesses to the drum, this may result in an uneven surface. The uneven surface may produce undesired results, such as wrinkling of the tire components during the build process.

Thus, an improved tire building drum and method of making a tire is desired which eliminates the wrinkling of tire components.

### Definitions

For ease of understanding this disclosure, the following items are defined:

“Apex” means an elastomeric filler located radially above the bead and interposed between the plies and the ply turn-up.

“Axial” and “axially” means the lines or directions that are parallel or aligned with the longitudinal axis of rotation of the tire building drum.

“Bead” means that part of the tire comprising an annular tensile member commonly referred to as a “bead core” wrapped by ply cords and shaped, with or without other reinforcement elements such as flippers, chippers, apexes, toe guards and chafers, to fit the design rim.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Carcass” means an unvulcanized laminate of tire ply material and other tire components cut to length suitable for splicing, or already spliced, into a cylindrical or toroidal shape. Additional components may be added to the carcass prior to its being vulcanized to create the molded tire.

“Casing” means the tire carcass and associated tire components excluding the tread.

“Chafers” refers to narrow strips of material placed around the outside of the bead to protect cord plies from the rim, distribute flexing above the rim, and to seal the tire.

“Circumferential” means lines or directions extending along the perimeter of the surface of the annular tread perpendicular to the axial direction.

“Cord” means one of the reinforcement strands of which the plies in the tire are comprised.

“Equatorial Plane (EP)” means the plane perpendicular to the tire's axis of rotation and passing through the center of its tread.

“Innerliner” means the layer or layers of elastomer or other material that form the inside surface of a tubeless tire and that contain the inflating fluid within the tire.

“Insert” means an elastomeric member used as a stiffening member usually located in the sidewall region of the tire.

“Ply” means a continuous layer of rubber-coated parallel cords.

“Radial” and “radially” mean directions radially toward or away from the axis of rotation of the tire building drum.

“Radial Ply Tire” means a belted or circumferentially restricted pneumatic tire in which at least one layer of ply has the ply cords extend from bead to bead at cord angles between 65° and 90° with respect to the equatorial plane of the tire.

“Shoulder” means the upper portion of sidewall just below the tread edge.

“Sidewall” means that portion of a tire between the tread and the bead.

“Tread” means a rubber component which when bonded to a tire carcass includes that portion of the tire that come into contact with the road when the tire is normally inflated and under normal load.

“Tread Width” means the arc length of the tread surface in the axial direction, that is, in a plane parallel to the axis of rotation of the tire.

### BRIEF DESCRIPTION OF THE DRAWINGS

The invention will be described by way of example and with reference to the accompanying drawings in which:

FIG. 1 is a front view of a tire building drum of the present invention;

FIG. 2 is a perspective view of a tire building drum of the present invention;

FIG. 3A is a side cross-sectional view of a tire building drum of the present invention, while FIG. 3B is a close up view of detail B of FIG. 3A;

FIG. 4 is a side cross-sectional view of a tire building drum of the present invention shown with tire building components thereon;

FIG. 5 is a close up view of one end of the tire building drum of FIG. 4 illustrating the placement of the bead, apex, ply and down ply;

FIG. 6a is a perspective view of the left hand side center sleeve component, while FIG. 6b is a top view of the left hand side center sleeve component;

FIG. 7 is a side view of the sleeve component;

FIGS. 8A-8E illustrate a method of forming a tire; and

FIGS. 9A-9F illustrate a method of forming a tire using the tire building drum of the present invention.

### DETAILED DESCRIPTION OF THE INVENTION

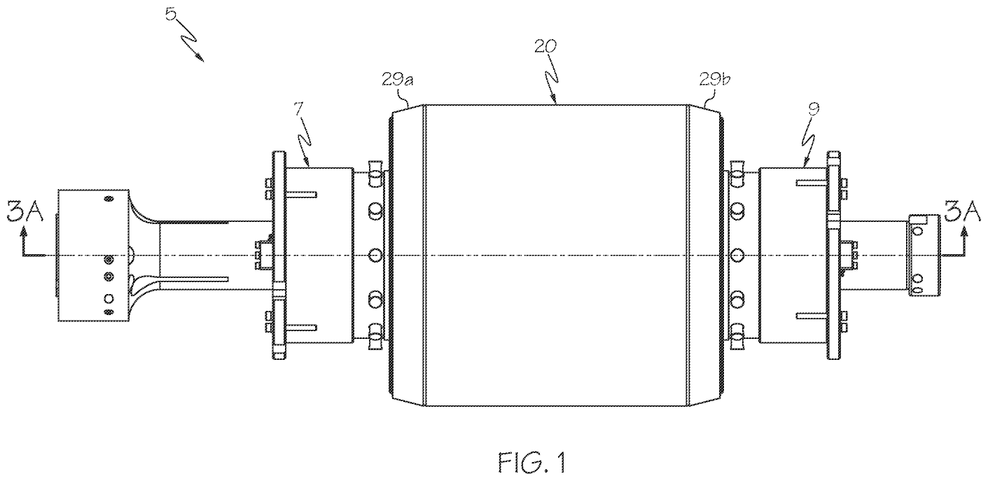

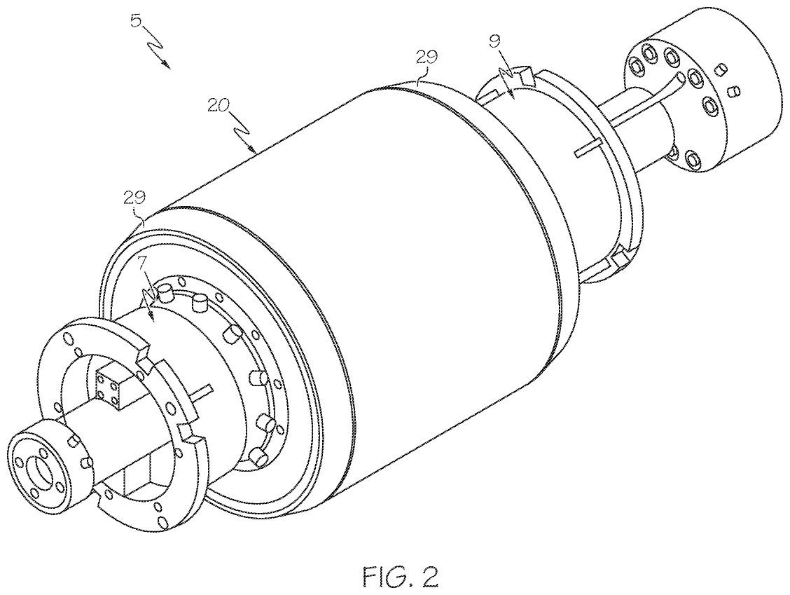

With reference to FIGS. 1 through 2, an exemplary tire building drum 5 of the present invention is illustrated. The tire building drum 5 of the present invention solves the problem of an uneven application surface during the tire building stage caused by the application of various tire components. The uneven surface may result in the wrinkling of tire components due to the uneven surface. The tire building drum 5 solves this problem by providing sloped segments which create a pocket for the varying thicknesses of the tire components to create an even or “flat” surface for the application of the down ply. The sloped segments are described in more detail, below.

The tire building drum 5 of the present invention is a full stage drum that can articulate from a fully collapsed position (not shown) to a radially expanded and axially contracted position. As shown more particularly in FIG. 1, the tire building drum 5 has a left hand side 7 and a right hand side 9 joined together by a center section 20.

The tire building drum includes a central drive shaft 120 that is provided for rotational movement of the tire building drum 5 about its longitudinal axis. The central shaft 120 is connected to a drive means (not shown). Provided within the central drive shaft 120 is a central screw 121. The central screw 121 is supported at each end by bearings 123. The threads on one side of the central screw 121 are left handed and on the opposite side are right handed. On the left hand side is an inboard nut 125 connected to the one end of the threaded screw 121 and similarly on the opposite right hand side is an outboard ball nut 125 connected to the central screw 121.

The left shoulder section 7 and right hand shoulder section 9 of the tire building drum are each axially slidable on respective bearing sleeves 8,10. The shoulder sections 7,9 are actuated by the central drive screw 121. Rotation of the central drive screw 121 moves the drive pins 125 mounted on nuts 130, which ride along the central drive screw 121. When the central screw is rotated, the nuts 130 move axially inward/outward, causing the drive pins 125 and each shoulder section to move axially inward/outward in corresponding fashion. In addition, the drive pins are also in mechanical cooperation with the split center segments, causing the split center segments 22a,b to axially extend or contract.

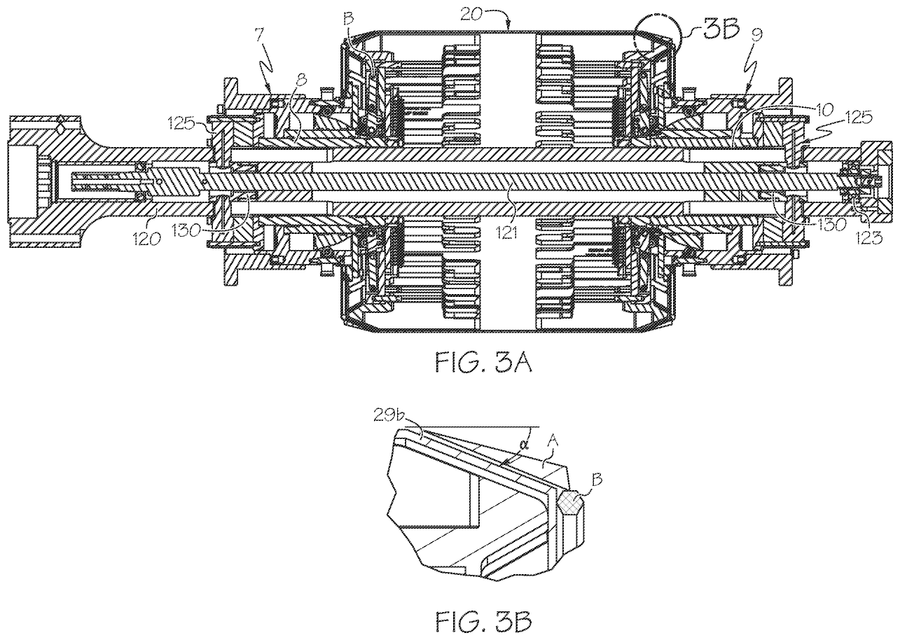

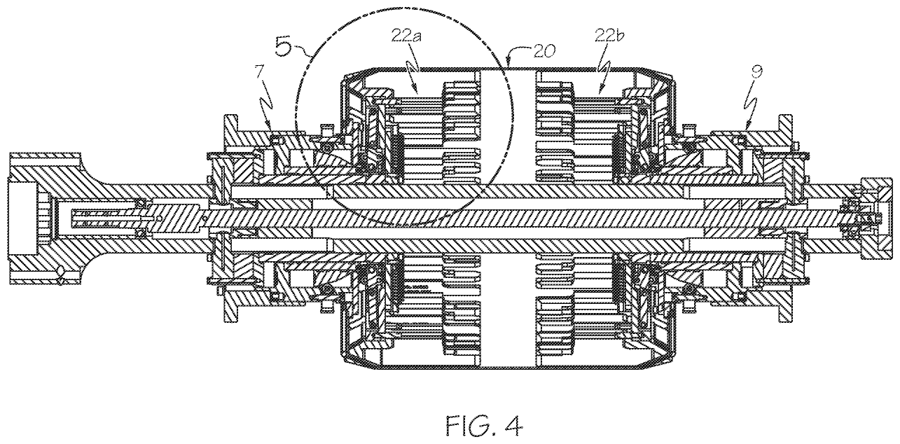

The center section 20 of the tire building drum as shown in FIGS. 3A and 4, further comprises a plurality of sloped segments 22a on the left side of the center section and a plurality of sloped segments 22b located on the right side of the drum. The sloped segments 22a,22b each have an angled outer surface 29a,29b located at the center section shoulders. The angled outer surface 29a,29b is angled at an angle α in the range of about 15 to about 45 degrees, more preferably in the range of about 15-30 degrees. FIGS. 3a and 3b illustrate the application of a tire bead B and an apex A. The angled outer surfaces create a pocket for the apex, ply and inner liner components so that a flat application surface is created for the application of a down ply. This solves the problem of the down ply wrinkling, or the problem of too much material such as the toeguard between the ply and down ply ending.

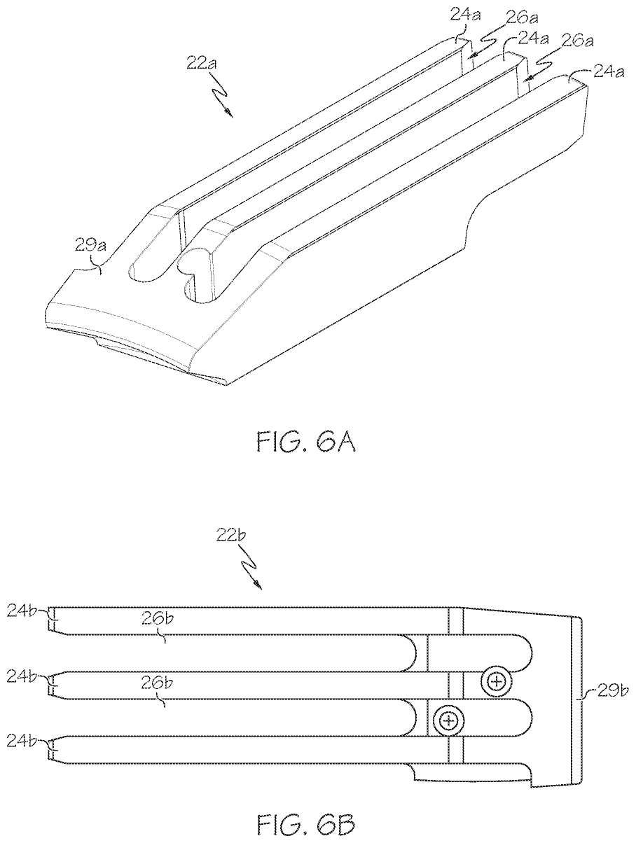

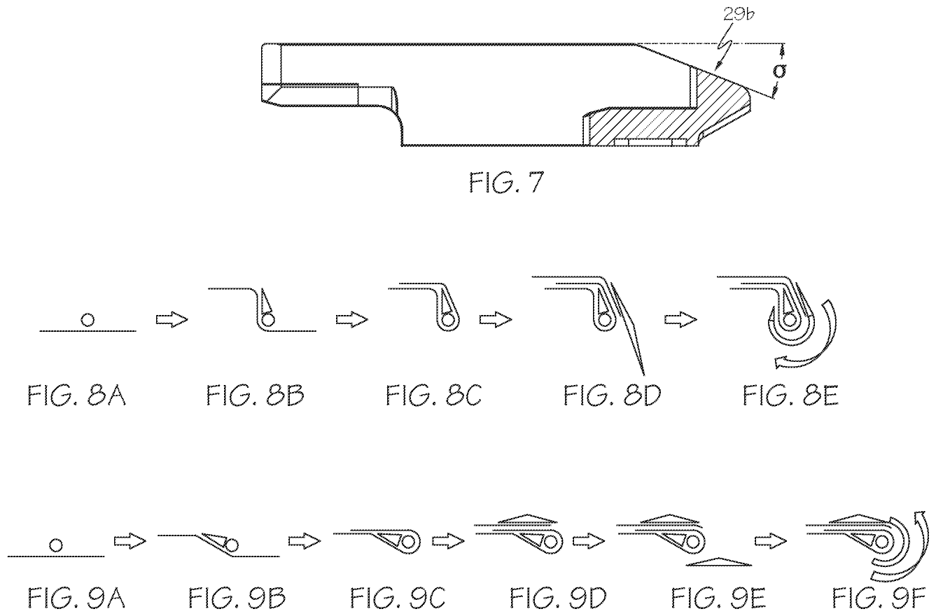

As shown in FIG. 6a, the left hand side center segment 22a has one or more finger like projections 24a, with recesses 26a. As shown in FIG. 6b, the right hand center segment 22a has three finger-like projections 24b with recesses 26b between the finger like projections 24b. The finger projections 24b of the right hand center segments are slidably received in the opposed elongate slots 26b of the left hand center segments so that the finger projections cooperate with the opposing slots in an interdigitated or interlocked manner. Likewise, the three finger like projections 24b are slidably received in three opposed elongate slots 26a. The center segments 22a,b thus cooperate with each other to allow the center section 20 to axially expand or contract due to the opposing fingers sliding within the opposing aligned recesses.

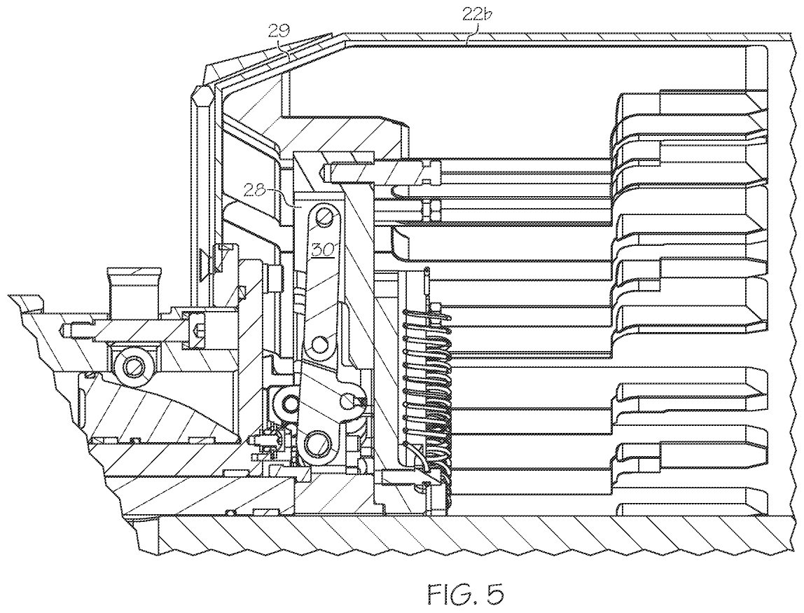

The center section 20 may also radially expand as shown in FIGS. 3-5. The center section 20 can radially expand in the range of about 20 to about 50 mm. As each center segment 22a,b radially expands, the gap between the center segments increases. As best shown in FIG. 5, provided within each center segment half 22a,b is a radially oriented piston chamber 28. Received in each chamber 28 is a linkage 30 connected to a common actuator (not shown), such as a piston. When the linkages 30 are actuated, the linkages push the center segments 22a,22b radially outward into the high crown position as shown in FIG. 5.

Adjacent the center section 20 are first and second bead locking mechanisms 25a,b, which are also radially expandable for engagement into the beads. With the drum of the present invention, the bead locking mechanism is independent of the drum crowning. After the carcass is made and the beads are locked, then the drum is crowned to reveal the specialized pocket for the apex to hide in, thereby allowing a flat surface for the down ply.

An upper bladder 150 extends axially outward from the bead lock mechanism 25 to the respective ends of the tire building drum. The upper bladder 150 extends over a lower bladder 152, which is mounted in the shoulder area of the drum and extends axially outward to the respective ends of the tire building drum. The upper and lower bladders function as turnup bladders which are used to inflate and, thereby, make the turn-up ends of the ply wrap about the apex and bead cores.

FIGS. 9a-f illustrated the new and improved tire building process using the drum of the present invention. The drum of the present invention eliminates the need for the extra step of turning down the entire assembly on a different station. The drum of the present invention produces a simplified turn down with no wrinkling of tire components. As shown in FIG. 9a, the beads are applied to the tire building drum surface. As shown in FIG. 9b, the center section of the drum is crowned using a much lower radial expansion (1.3 inches) the radial expansion of a high crown drum. (2 inches or more). Next, the apex or bead and apex combination is applied to each sloped shoulder 29 of the drum of the present invention as shown in FIG. 9b. Next as shown in FIG. 9c, the ply is turned up over the bead and apex as shown, forming a flat surface to apply the additional tire components such as a down ply and a second apex. As shown in FIG. 9d, a down ply that has been stretched is then applied, an optional second apex and/or chafer may additionally be applied. AS shown in FIG. 9e, the bead lock is released and a chafer is applied under the bead. As shown in FIG. 9f, the bead is locked and the chafer is turnup up over the bead.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire building drum comprising: a rotatable drum having a center section and a first and second shoulder section, said center section being radially expandable, wherein said center section has a first and second shoulder, wherein the first and second shoulders are sloped.

2. The tire building drum of claim 1 wherein the first and second shoulders are sloped at an angle in the range of 10 to 45 degrees.

3. The tire building drum of claim 1 wherein the first and second shoulders are sloped at an angle in the range of 15 to 30 degrees.

4. The tire building drum of claim 1 wherein said center section further comprising a first half and a second half, wherein the first half and the second half are axially movable with respect to each other so that the center section has an adjustable width.

5. The tire building drum of claim 1 wherein said center section segments further comprise a first half and a second half, wherein the first half is slidably mounted within the second half.

6. The tire building drum of claim 2 wherein the first half is interlocked with respect to the second half.

7. A method of building a tire comprising the steps of providing a tire building drum having a center section with shoulders having sloped ends, applying an inner liner and a layer of ply to the drum and then a bead, locking the bead into position, applying an apex to each of the sloped shoulders, turning up the ply over the bead and the apex, and then applying a down ply over the ply ending.

8. The method of building a tire of claim 7 wherein the first and second shoulders are sloped at an angle in the range of 10 to 45 degrees.

9. The method of building a tire of claim 7 wherein the first and second shoulders are sloped at an angle in the range of 15 to 30 degrees.

10. The method of building a tire of claim 7 wherein said center section further comprising a first half and a second half, wherein the first half and the second half are axially movable with respect to each other so that the center section has an adjustable width.

11. The method of building a tire of claim 7 wherein said center section segments further comprise a first half and a second half, wherein the first half is slidably mounted within the second half.

12. The method of building a tire of claim 8 wherein the first half is interlocked with respect to the second half.

13. The method of building a tire of claim 7 further comprising the step of unlocking the bead lock mechanism and then applying a chafer under the bead.

14. The method of claim 7 further comprising the step of locking the bead and then turning up the chafer over the bead.
